(19) United States
(12) Patent Application Publication
(10) Pub. No.: US 2008/0224544 A1
(43) Pub. Date: Sep. 18, 2008

(54) Electric power supply device, information processing device, and display device

(75) Inventor: Fumio Koyama, Hara-mura (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/075,681

(22) Filed: Mar. 13, 2008

(30) Foreign Application Priority Data
Mar. 14, 2007 (JP) 2007-064518
Dec. 3, 2007 (JP) 2007-312592

(51) Int. Cl. H01F 38/14; H02J 5/00

(52) U.S. Cl. 307/104

(57) ABSTRACT

There is disclosed an electric power supply device including: a plurality of coils that respectively generate alternating current signals depending on a variation in magnetic flux; a plurality of rectifying units that are respectively connected to the plurality of coils, to respectively convert the alternating current signals generated by the plurality of coils connected, into a plurality of direct current signals; a restriction unit that restricts reverse flow of the plurality of direct current signals converted by the plurality of rectifying units; an electric power supply unit that extracts and supplies electric power from the plurality of direct current signals flowing through the restriction unit; and an output unit that specifies a direct current signal at a highest level among the plurality of direct current signals converted by the plurality of rectifying units, and outputs electronic information specifying which of the plurality of coils is connected to one of the plurality of rectifying units that has generated the direct current signal at the highest level.

The entire disclosures of Japanese Patent Application No. 2007-312592 filed on Dec. 3, 2007 and Japanese Patent Application No. 2007-064518 filed on Mar. 14, 2007 are expressly incorporated by reference thereto, herein.

### BACKGROUND

1. Technical Field

The present invention relates to a technique for electromagnetically receiving external electric power supply.

2. Related Art

There are known techniques for supplying electric power by utilizing the phenomenon of electromagnetic induction. Another known technique (e.g., JP-A-2005-312285) discloses that a plurality coils are provided in each of a power supplying device and a power receiving device in order to increase electric power supplied in a manner similar to the foregoing known techniques.

### SUMMARY

However, only an increase in supplied electric power is expected to be obtained from the technique of simply providing plural coils. The invention is therefore directed to providing a technique by which not only a supplied electric power is increased but also additional functions are provided, when externally supplied electric power is received electromagnetically.

According to one aspect of the invention, there is provided an electric power supply device including: a plurality of coils that respectively generate alternating current signals depending on a variation in magnetic flux; a plurality of rectifying units that are respectively connected to the plurality of coils, to respectively convert the alternating current signals generated by the plurality of coils connected, into a plurality of direct current signals; a restriction unit that restricts reverse flow of the plurality of direct current signals converted by the plurality of rectifying units; an electric power supply unit that extracts and supplies electric power from the plurality of direct current signals flowing through the restriction unit; and an output unit that specifies a direct current signal at the highest level among the plurality of direct current signals converted by the plurality of rectifying units, and outputs electronic information specifying which of the plurality of coils is connected to one of the plurality of rectifying units that has generated the direct current signal at the highest level.

According to another aspect of the invention, there is provided an electric power supply device including: a plurality of coils that respectively generate alternating current signals depending on a variation in magnetic flux; a plurality of rectifying units that are respectively connected to the plurality of coils, to respectively convert the alternating current signals generated in the plurality of coils connected, into a plurality of direct current signals; an electric power supply unit that extracts and supplies electric power from the plurality of direct current signals converted by the plurality of rectifying units; and an output unit that specifies a direct current signal at the highest level among the plurality of direct current signals generated in the plurality of coils, and outputs electronic information specifying which of the plurality of coils has generated the direct current signal at the highest level.

The electric power supply devices as described above each is capable of not only supplying electric power by using a plurality of coils but also is capable of specifying which coil has generated a primary signal (i.e., the signal at the highest level). Accordingly, a device which is operated by electric power supplied from any of the electric power supply devices described above is capable of executing a processing associated with a specified coil.

Each of the electric power supply devices as described above can be alternatively configured as follows. That is, each of the plurality of coils is sorted in any of a plurality of groups, and the output unit is provided in a plurality so that a plurality of output units are respectively associated with the plurality of groups, and each of the plurality of output units outputs electronic information specifying any coil sorted in associated one of the plurality of groups. By using this configuration, types of content expressed by combining electronic information output from plural groups can be increased.

Also each of the electric power supply device as described above can be alternatively configured as follows. That is, each of the alternating current signals includes superimposed information modulated in accordance with a modulation method, and the electric power supply device further includes a demodulation unit that specifies an alternating current signal at a highest level among the plurality of alternating current signals, in accordance with the electronic information output from the output unit, and executes a demodulation processing suitable for the modulation method on the alternating current signal, thereby to obtain the superimposed information. By using this configuration, superimposed information can be obtained in addition to electronic information specifying a coil.

Also each of the electric power supply devices, as described above, can be alternatively configured so that the plurality of rectifying units respectively include smoothing units that reduce ripples of the converted plurality of direct current signals. By using this configuration, more stable direct current signals, which have fewer variants, can be obtained.

Also each of the electric power supply device as described above can be alternatively configured so as to further include a plurality of capacitors that are respectively connected to the plurality of coils and resonate with an alternating current signal having a predetermined frequency. By using this configuration, a signal having a desired frequency can be efficiently obtained.

According to still another aspect of the invention, there is provided an information processing device including: a plurality of coils that are respectively provided at predetermined positions and also respectively generate alternating current signals depending on a variation in magnetic flux; a plurality of rectifying units that are respectively connected to the plurality of coils, to respectively convert the alternating current signals generated in the plurality of coils connected, into a plurality of direct current signals; a restriction unit that restricts reverse flow of the plurality of direct current signals converted by the plurality of rectifying units; an electric power supply unit that extracts and supplies electric power from the plurality of direct current signals flowing through the restriction unit; a specifying unit that specifies a direct current signal at the highest level among the plurality of direct current signals converted by the plurality of rectifying units, thereby to specify which of the plurality of coils is connected to one of the plurality of rectifying units that has generated the direct current signal at the highest level; and a processing execution unit that executes a processing suitable for the which of the plurality of coils specified by the specifying unit, by utilizing the electric power supplied from the electric power supply unit.

According to still another aspect of the invention, there is provided an information processing device including: a plurality of coils that are respectively provided at predetermined positions and also respectively generate alternating current signals depending on a variation in magnetic flux; a plurality of rectifying units that are respectively connected to the plurality of coils, to respectively convert the alternating current signals generated in the plurality of coils connected, into a plurality of direct current signals; an electric power supply unit that extracts and supplies electric power from the plurality of direct current signals converted by the plurality of rectifying units; a specifying unit that specifies a direct current signal at a highest level among the plurality of direct current signals generated in the plurality of coils, thereby to specify which of the plurality of coils has generated the direct current signal at the highest level; and a processing execution unit that executes a processing suitable for the which of the plurality of coils specified by the specifying unit, by utilizing the electric power supplied from the electric power supply unit.

A practical example for both the information processing devices described above would be an electronic non-volatile (i.e. image-retaining) display device capable of retaining an image after power supply to the device is cut. The device may include a display that displays an image by using an electronic non-volatile display medium (an electrophoresis display device, for example) and execute, as in the processing also described above, a processing concerning display operations performed by the display.

### BRIEF DESCRIPTION OF THE DRAWINGS

Exemplary embodiments of the invention will now be described in detail based on the following drawings wherein:

FIG. 1 schematically shows an information display system according to the invention;

FIG. 2 is a block diagram showing the entire structure of the information display system;

FIG. 3 shows a structure of a primary coil unit;

FIG. 4 partially shows a circuit structure of a display device;

FIG. 5 shows a display screen side of the display device;

FIG. 6 is a cross-sectional view of the display device;

FIG. 7 is a block diagram showing the entire structure of the display device;

FIG. 8 partially shows a circuit structure of the display device:

FIG. 9 shows a modification of the display device;

FIG. 10 shows another modification of the display device;

FIG. 11 shows a modification of the information display system;

FIG. 12 shows a still another modification of the display device;

FIG. 13 also shows a still another modification of the display device; and

FIG. 14 shows a still another modification of the display device.

### DESCRIPTION OF EXEMPLARY EMBODIMENTS

Exemplary embodiments of the present invention will now be described with reference to the drawings.

### First Exemplary Embodiment

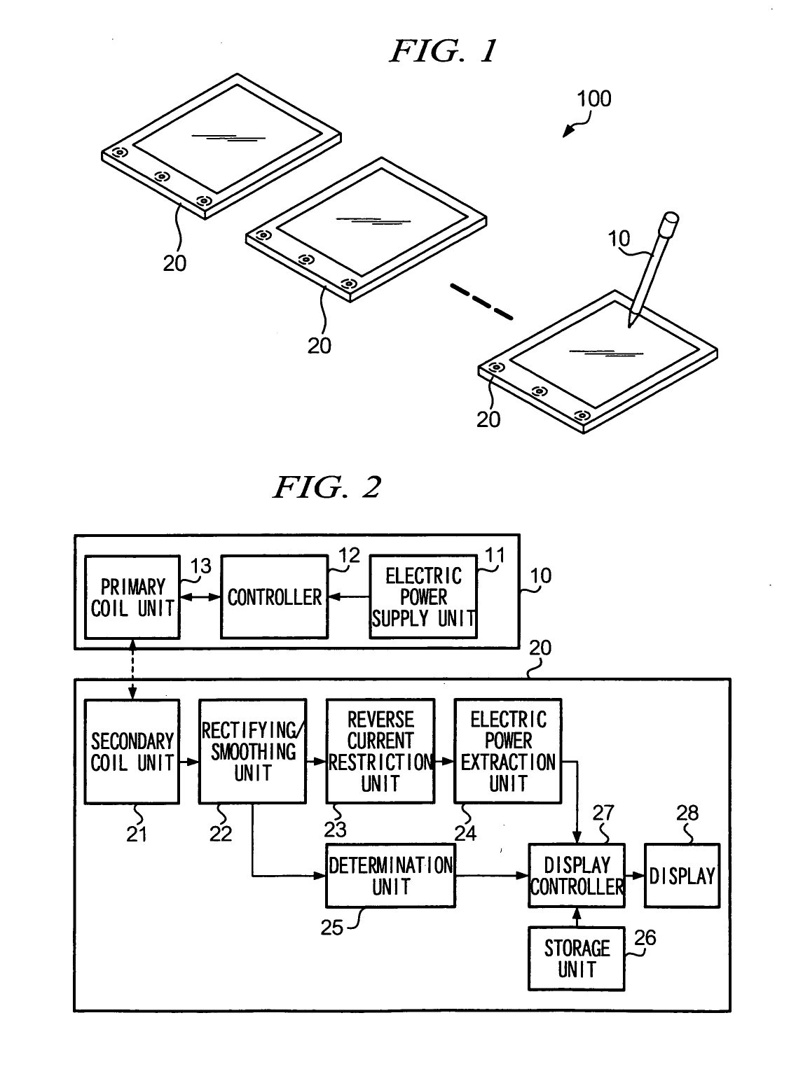

FIG. 1 schematically shows an information display system according to the first exemplary embodiment of the invention. As shown in the figure, an information display system 100 according to the embodiment has an instruction device 10 and plural display devices 20. The instruction device 10 is a pen-type processing device which supplies the plural display devices 20 with various instructions concerning display operations and supplies electric power for operating the display devices 20. Each of the display devices 20 functions as so-called electronic paper, and performs display operations in accordance with instructions supplied from the instruction device 10. In this embodiment, the instruction device 10 and display devices 20 communicate with each other in accordance with an electronic coupling method using a predetermined frequency band.

FIG. 2 is a block diagram showing an entire structure of the information display system 100. Since the display devices 20 have a common structure, and for the sake of brevity, reiterative descriptions of such common structures will be omitted from the following description. As shown in the figure, the instruction device 10 has a power supply unit 11, a controller 12, and a primary coil unit 13. Each of the display devices 20 has a secondary coil unit 21, a rectifying/smoothing unit 22, a reverse current restriction unit 23, an electric power extraction unit 24, a determination unit 25, a storage unit 26, a display controller 27, and a display 28.

The power supply unit 11 supplies electric power for operating the instruction device 10 and display devices 20. The power supply unit 11 has a battery as a power supply source, e.g., a dry cell battery or storage battery. The controller 12 includes a CPU (Central Processing Unit), memory, etc., and controls operation of the instruction device 10. The controller 12 controls operation of the primary coil unit 13 by supplying predetermined alternating current signals. The primary coil unit 13 is an interface for supplying electric power to the display devices 20, and generates magnetic flux depending on the alternating current signals.

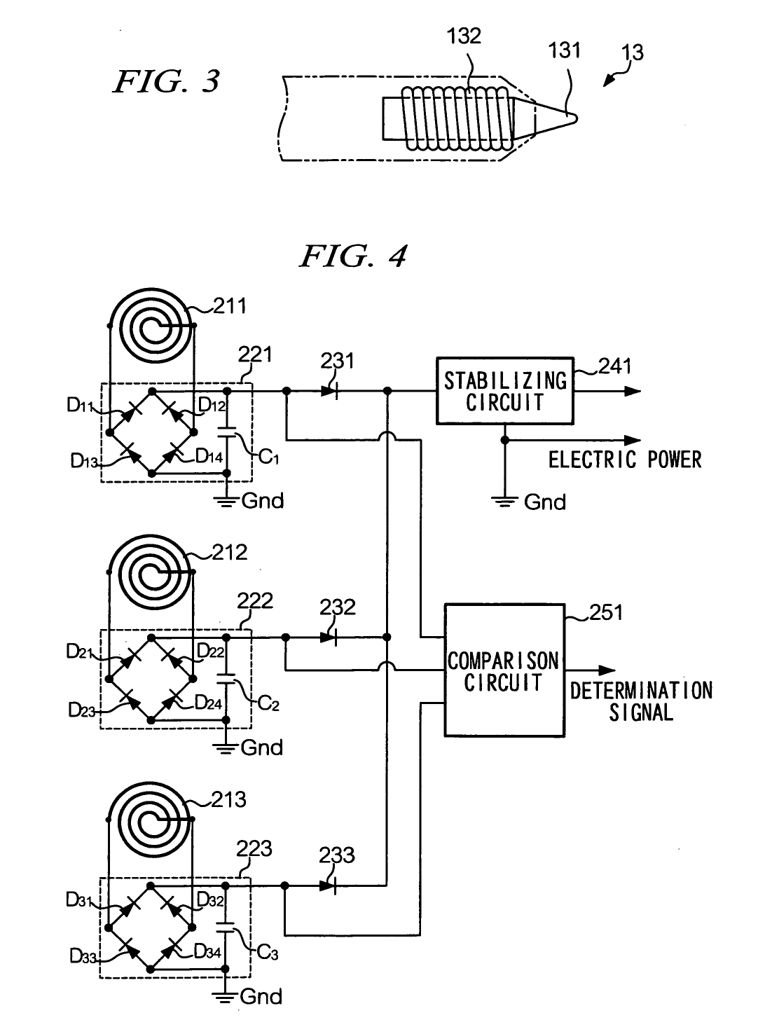

FIG. 3 shows a structure of the primary coil unit 13. The primary coil unit 13 has a magnetic core 131, and a coil 132 which is wound around the magnetic core 13 1. The magnetic core 131 desirably has a conical top end to perform efficient electromagnetic coupling with the secondary coil unit 21.

The secondary coil unit 21 is an interface for receiving electric power supply from the instruction device 10. The secondary coil unit 21 has plural spiral coils. Each of the spiral coils is a planar coil which is formed by spiral winding of a lead wire. The spiral coils each have a diameter of about 10 mm and generate a signal in accordance with an electric current which depends on variation in magnetic flux. The generated signal is an alternating current signal because the instruction device 10 generates an alternating magnetic field.

The rectifying/smoothing unit 22 converts alternating current signals generated at the secondary coil unit 22 into direct current signals. The rectifying/smoothing unit 22 has plural rectifying/smoothing circuits. The rectifying/smoothing unit 22 converts alternating current signals into direct current signals by use of rectifying circuits, and smoothes the direct current signals by use of smoothing circuits. Before passing through the rectifying circuits, the direct current signals are in the form of so-called pulsating currents; and while passing through the smoothing circuits, ripples in the direct current signals are reduced. Full wave rectifiers or half wave rectifiers are available for use as rectifying circuits. In this embodiment, bridged full wave rectifiers are used. The smoothing circuits are capacitors.

The reverse current restriction unit 23 restricts reverse flow of the direct current signals supplied from the rectifying/smoothing unit 22 so that the direct current signals properly flow to the electric power extraction unit 24. The reverse current restriction unit 23 is constituted by, for example, diodes.

The electric power extraction unit 24 extracts electric operation power from the direct current signals supplied through the reverse current restriction unit 23. The electric power extraction unit 24 has, for example, a stabilizing circuit. The electric power extraction unit 24 supplies the extracted electric operation power to the display controller 27.

The determination unit 25 makes a determination on plural direct current signals supplied from the rectifying/smoothing unit 22, to specify which of the plural direct current signals is presently at a highest level. The determination unit 25 has, for example, a comparison circuit which has the same number of terminals as the number of spiral coils, and outputs a signal indicating which terminal is generating the greatest direct current signal. This signal will be hereinafter called a “determination signal”. Determination signals constitute information and can respectively identify individual ones of the plurality of spiral coils.

The storage unit 26 stores display data. The storage unit 26 has, for example, a rewritable storage medium such as a flash memory. This storage medium desirably has a so-called detachable structure which is generally employed in memory cards. The display data stored in the storage unit 26 is information indicating texts and images to be displayed by the display devices 20. This information is divided into units in pages to be displayed on the display screen of the display devices 20. In this embodiment, the display data is configured so that plural pages constitute one document. The storage unit 26 stores a plurality of display data corresponding in number to documents.

The display controller 27 has a drive circuit for driving the display 28 and controls a display on the display 28. The display controller 27 obtains display data from the storage unit 26 and supplies the display 28 with a drive voltage in accordance with the obtained display data. The display controller 27 obtains a determination signal from the determination unit 25 and controls, for example, switching of display data to be displayed in accordance with the determination signal.

The display 28 displays text and images on a predetermined display screen. The display screen of the display 28 is constituted of plural pixels each of which expresses a gradation tone corresponding to a supplied drive voltage. In this embodiment, each of the pixels constituting the display 28 has a liquid crystal layer in which memory liquid crystal is used. The term “memory liquid crystal” refers to a kind of liquid crystal that is capable of maintaining a display state (e.g., displayed gradation tones) without the need for continuous application of an electric voltage. An available example of such a memory liquid crystal is a cholesteric liquid crystal.

Structures of the secondary coil unit 21, the rectifying/smoothing unit 22, the reverse current restriction unit 23, the electric power extraction unit 24, and the determination unit 25 will now be described specifically.

FIG. 4 partially shows a circuit structure of the display device(s) 20. The secondary coil unit 21 has spiral coils 211, 212, and 213. The rectifying/smoothing unit 22 has rectifying/smoothing circuits 221, 222, and 223. The reverse current restriction unit 23 has diodes 231, 232, and 233. The electric power extraction unit 24 has a stabilizing circuit 241, and the determination unit 25 has a comparison circuit 251.

The rectifying/smoothing circuit 221 is connected to the spiral coil 211 and has diodes D11, D12, D13, and D14, and a capacitor C1. The diodes D11, D12, D13, and D14 constitute a bridged circuit. An end of the spiral coil 211 is connected to an anode side of the diode D11 and a cathode side of the diode D13. Another end of the spiral coil 211 is connected to an anode side of the diode D12 and a cathode side of the diode D14. The capacitor C1 has an end which is connected to anode sides of the diodes D13 and D14 and also to a ground potential (Gnd). Another end of the capacitor C1 is connected to cathode sides of the diodes D11 and D12.

The rectifying/smoothing circuit 222 has diodes D21, D22, D23, and D24 and a capacitor C2 and has the same structure as the rectifying/smoothing circuit 221. The rectifying/smoothing circuit 223 has diodes D31, D32, D33, and D34 and a capacitor C3 and has the same structure as the rectifying/smoothing circuit 221. The rectifying/smoothing circuit 222 is connected to the spiral coil 212, as well as the rectifying/smoothing circuit 223 to the spiral coil 213. That is, the rectifying/smoothing circuit 222 is associated with the spiral coil 212, as well as the rectifying/smoothing circuit 223 with the spiral coil 213.

Each of outputs from the rectifying/smoothing circuits 221, 222, and 223 is divided into a couple of branch paths. One of each couple of branch paths reaches corresponding one of diodes 231, 232, and 233. The other one of each couple of branch paths reaches the comparison circuit 251. That is, the comparison circuit 251 is supplied with direct current signals before being input to the diodes 231, 232, and 233. The direct current signals supplied to the diodes 231, 232, and 233 are also supplied to the stabilizing circuit 241.

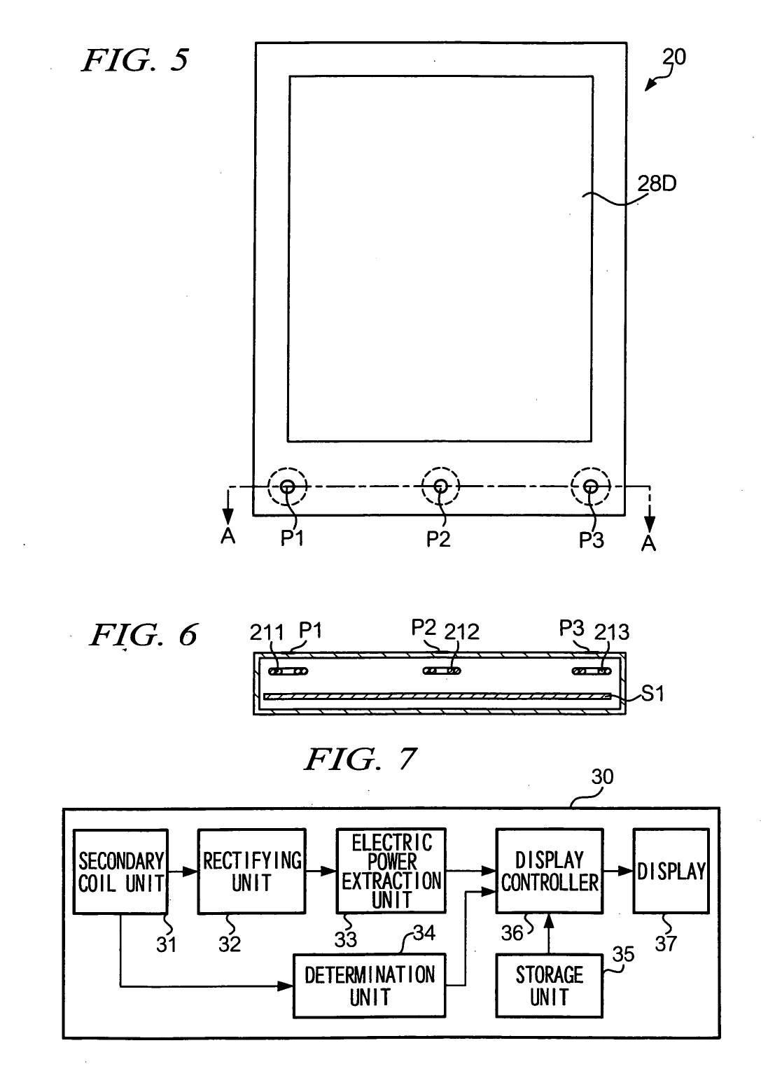

FIG. 5 shows a display screen side of one of the display devices 20. As indicated in the figure, each of the display devices 20 has a display screen 28D and plural operation points P1, P2, and P3. Predetermined operations are respectively assigned to the operation points P1 to P3. The operations assigned to the operation points P1 to P7 are, for example, performing page turning when display data is being displayed, along with various other settings and corresponding instructions. The operation points P1 to P3 are respectively associated with the spiral coils 211 to 213. For example, the operation point P1 is associated with the spiral coil 211, and the operation point P2 is associated with the spiral coil 212. That is, a number of operation points is equal to a number of spiral coils. At positions corresponding to the operation points P1 to P3, there is printed either text or images for indicating the corresponding points.

FIG. 6 is a cross-sectional view of one of the display devices 20 cut along a line A-A in FIG. 5. FIG. 6 shows the display screen side facing upwards. As shown in the figure, the spiral coils 211 to 213 are respectively provided below associated operation points P1 to P3. A magnetic absorption layer S1 is provided below the spiral coils 211 to 213 so as to face the lower faces of the spiral coils 211 to 213. The magnetic absorption layer S1 is formed of a sheet-like material containing a soft magnetic material as a raw material although the layer S1 is merely an example of available magnetic absorption members appropriate for use in the invention. The magnetic absorption layer S1 needs only to be provided at least below the spiral coils 211 to 213 but can be provided so as to cover a broader area. For example, the magnetic absorption layer S1 covers an area substantially equal to the upper face of the display device 20. The magnetic absorption layer S1 can be constituted of plural small pieces of sheets which are respectively associated with the spiral coils 211 to 213.

The structure of the information processing system has been described above. With this structure, the information display system 100 displays text and images on the plural display devices 20. In the information display system 100, a user conducts operations by holding the instruction device 10 in one hand and by using the instruction device 10 as a writing tool such as a pen would be used. The operations can consist of, for example, actions of touching a center of one of the operation points P1 to P3 with the top end part of the instruction device 10. In this case, the top end part of the instruction device 10 is desirably brought into direct contact with the operation points Pa to P3. However, the top end part can be spaced slightly apart from the points, by a distance of up to several mm.

The top end part of the instruction device 10 and one or more of the spiral coils 211 to 213 are positioned to be closely proximate to each other at a predetermined distance. The close proximate spiral coil and a primary coil unit 13 are electromagnetically coupled together. Electric power is thereby supplied to the display device 20, which performs a display operation on the display 25.

At this time, the display controller 27 controls display in accordance with a determination signal. For example, if a determination signal indicates the spiral coil 211 (i.e., when the instruction device 10 is closely proximate to the spiral coil 211), an immediately previous page to the page being presently displayed is then displayed, under control of the display controller 27. If the determination signal indicates the spiral coil 213, a next page to the page being presently displayed is then displayed. If the determination signal indicates the spiral coil 212, the document being presently displayed is switched to another document.

As has been described above, in the display devices 20 a configuration is adopted in which direct current signals before being input to the diodes 231, 232, and 233 are input to the determination unit 25. Therefore, which spiral coil is positioned most closely proximate to the instruction device 10 can be determined while preventing interference among each of the spiral coils. Each of the display devices 20 is therefore able to specify which operation point is selected by the user, and to execute a processing associated with the selected operation point.

### Second Embodiment

A second exemplary embodiment of the present invention will be described next. Lots of features of the configuration of the second exemplary embodiment are common to those of the configuration of the first exemplary embodiment described above. For the sake of brevity, reiterative descriptions of such common features will be omitted from the following descriptions which will be mainly directed to features that are different from those described in the first exemplary embodiment. In the second exemplary embodiment, components given the same names as in the first exemplary embodiment have the same main functions as those described in the first exemplary embodiment, respectively.

FIG. 7 is a block diagram showing an entire structure of a display device 30. As shown in the figure, the display device 30 has a secondary coil unit 31, a rectifying unit 32, a power extraction unit 33, a determination unit 34, a storage unit 35, a display controller 36, and a display 37. Compared with the display devices 20 of the first exemplary embodiment, the display device 30 of the second exemplary embodiment differs in that the display device 30 includes a “rectifying unit 32” in place of the “rectifying/smoothing unit 22” and does not have a structure equivalent to the “reverse current restriction unit 23”.

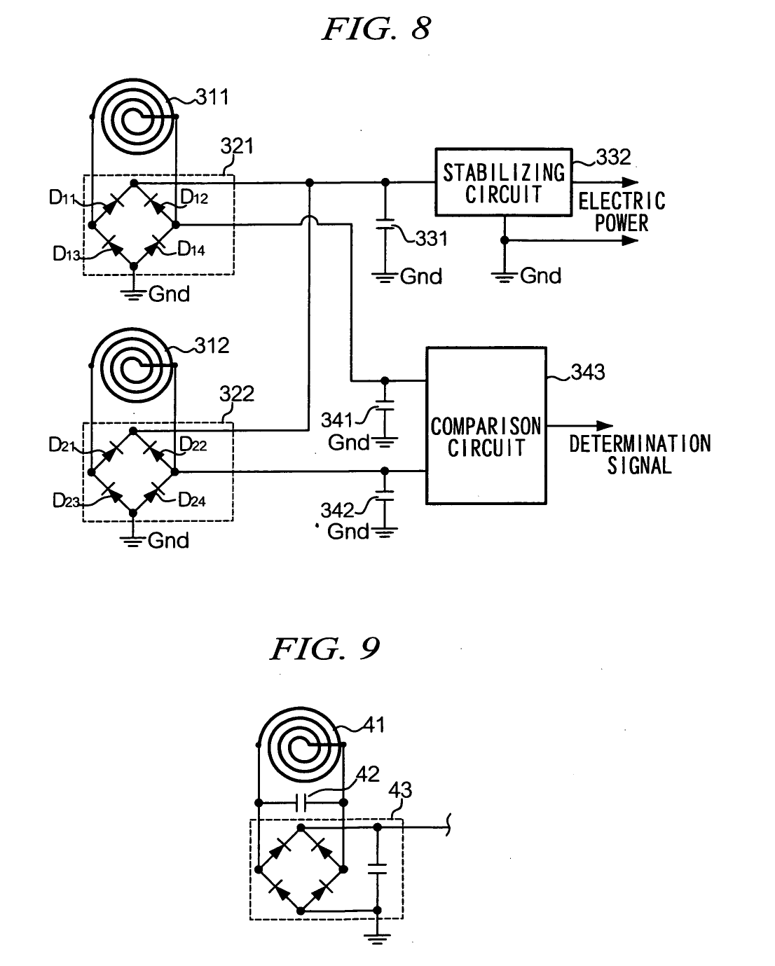

FIG. 8 partially shows a circuit structure of the display device 30. The secondary coil unit 3 1 has spiral coils 3 11 and 3 12, and the rectifying unit 32 has rectifying circuits 321 and 322. The electric power extraction unit 33 has a capacitor 331 and a stabilizing circuit 332. The determination unit 34 has capacitors 341 and 341 and a comparison circuit 343. The rectifying circuits 321 and 322 respectively have bridged circuits (constituted by diodes D11 to D14 and diodes D21 to D24) which are similar to those of the rectifying/smoothing circuits 221 and 222.

The comparison circuit 343 compares an alternating current signal supplied from an end of the spiral coil 311, which functions as an anode end of the diode D12, with an alternating current signal supplied from an end of the spiral coil 312, which functions an anode end of the diode D22. The comparison circuit 343 thereby specifies which coil outputs a greater amount of alternating current signal. The comparison circuit 343 then outputs a determination signal specifying the spiral coil which has output the greater amount of specified alternating current signal.

The display device 30 according to the second exemplary embodiment can also perform the same effects as the display devices 20 according to the first embodiment. In the display device 30 according to the second exemplary embodiment, the diodes D12 and D22 perform the same functions as the diodes 231 and 232. Specifically, the diodes D12 and D22 function to restrict reverse flow of direct current signals supplied to the electric power extraction unit 33. The display device 30 according to the second exemplary embodiment is further able to specify an operation point pointed out by the user, and to execute a processing associated with the operation point.

Modifications

The invention is not limited to the exemplary embodiments described above but can be variously modified in practice. For example, in the above embodiments, display devices 20 (or 30) for display purpose are adopted as an example of the information processing device according to the invention. Devices used for other purposes are also available. In brief, the information processing device according to the invention can be any device in so far as the device executes any processing by utilizing electric power supplied from the instruction device 10. In addition, the above embodiments are configured so that one single instruction device 10 gives instructions to plural display devices 20. However, the configuration can be modified so that one instruction device 10 gives instructions to only one display device 20.

A greater number of spiral coils than used in the first exemplary embodiment can be provided. If the number of spiral coils is increased, the determination unit 25 (or 34) is then able to attain more various determination results, which allow a user to give even more complex instructions.

The spiral coils can be provided below the display screen. In this case, a touch-panel-like operation means can be attained by displaying images on the display screen at positions corresponding to the spiral coils. Specifically, in the display device configured in this manner, predetermined operations can be executed as the images displayed on the display screen are selected as operation points by the instruction device 10.

The configuration for performing rectification is not limited to a bridged circuit. For example, a half wave rectifying circuit or a voltage doubler rectifying circuit can be used. Components used for restricting reverse current flow or for the rectification are not limited to diodes but can be elements or circuits such as field effect transistors, which have functions equivalent to those of diodes.

The configuration can be alternatively modified so that a resonant capacitor is connected in parallel with the spiral coil in the front side of each rectifying/smoothing circuits (or rectifying circuits). A resonance frequency of the resonant capacitor is determined depending on a frequency band to be used.

FIG. 9 shows an example of a case of connecting such a resonant capacitor. As shown in the figure, a resonant capacitor 42 is connected in parallel with each spiral coil 41 before a bridged circuit 43.

Also, the above embodiments are configured so that signals from all spiral coils provided in each of the display devices 20 (or 30) are input to one single determination unit 25 (or 34). However, the spiral coils can be divided into plural groups, and determination units can be provided respectively for the plural groups.

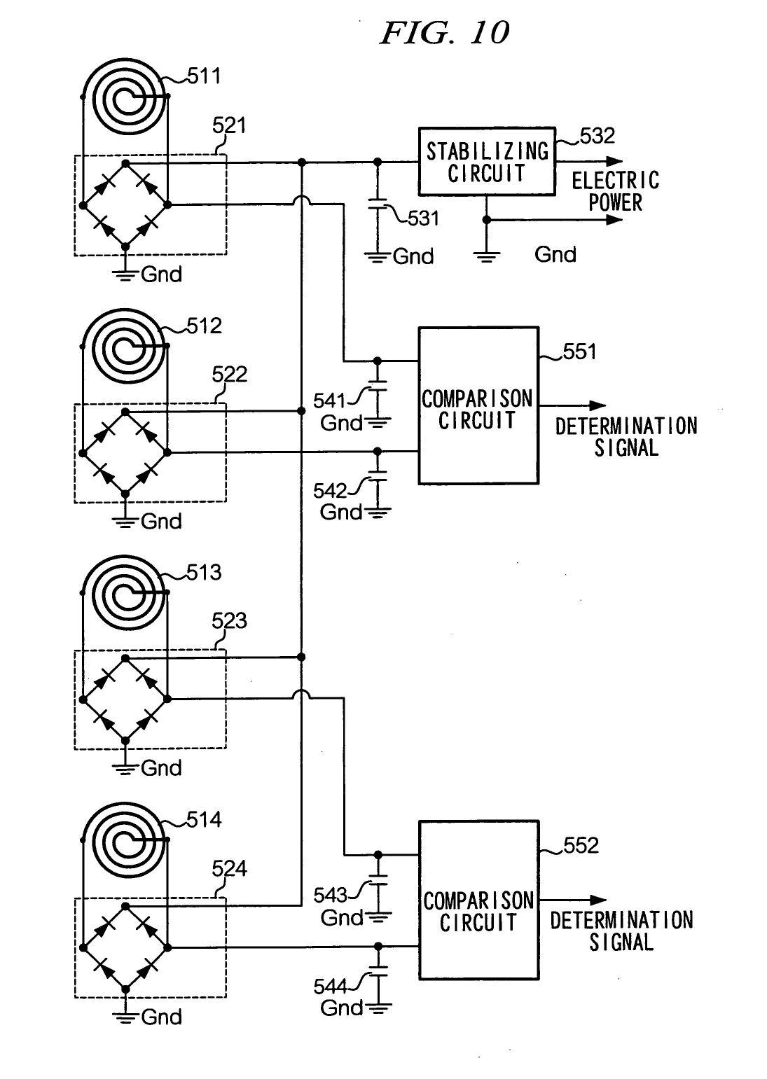

FIG. 10 shows an example of the case of providing plural determination units as described above. In the figure, spiral coils 511 and 512 constitute a first group, and the spiral coils 513 and 514 constitute a second group. A stabilizing circuit 532 is input with all direct current signals which are respectively supplied from the rectifying circuit 521, 522, 523, and 524 and smoothed by a capacitor 531. A comparison circuit 551 is input with direct current signals which are respectively supplied from the rectifying/smoothing circuits 521 and 522 and also respectively smoothed by capacitors 541 and 542. On the other side, into the comparison circuit 552 there are input direct current signals which are respectively supplied from the rectifying/smoothing circuits 523 and 524, which signals are also respectively smoothed by capacitors 543 and 544.

In the same manner as described above, spiral coils can be grouped into three or more groups, into each of which three or more spiral coils are grouped. At the same time, the same number of comparison circuits as the three or more groups can be provided. In this manner, a number of types of information which are respectively indicated by determination signals can be increased to be greater than the number of spiral coils. If m spiral coils are divided into n groups, the types of information indicated by determination signals can reach total mⁿ (n power of m).

In the above embodiments, signals transmitted by the instruction device 10 are equivalent only to power. However, the above embodiments can be modified so as to transmit a signal obtained by superimposing information on electric power. In this modified configuration, a greater amount of information can be supplied to the display devices 20 (or 30). In order to achieve such a modified configuration, the instruction device 10 needs only to modulate and superimpose information on signals in accordance with a predetermined modulation method. The display devices 20 (or 30) need only to perform a demodulation processing to separate information and electric power from signals.

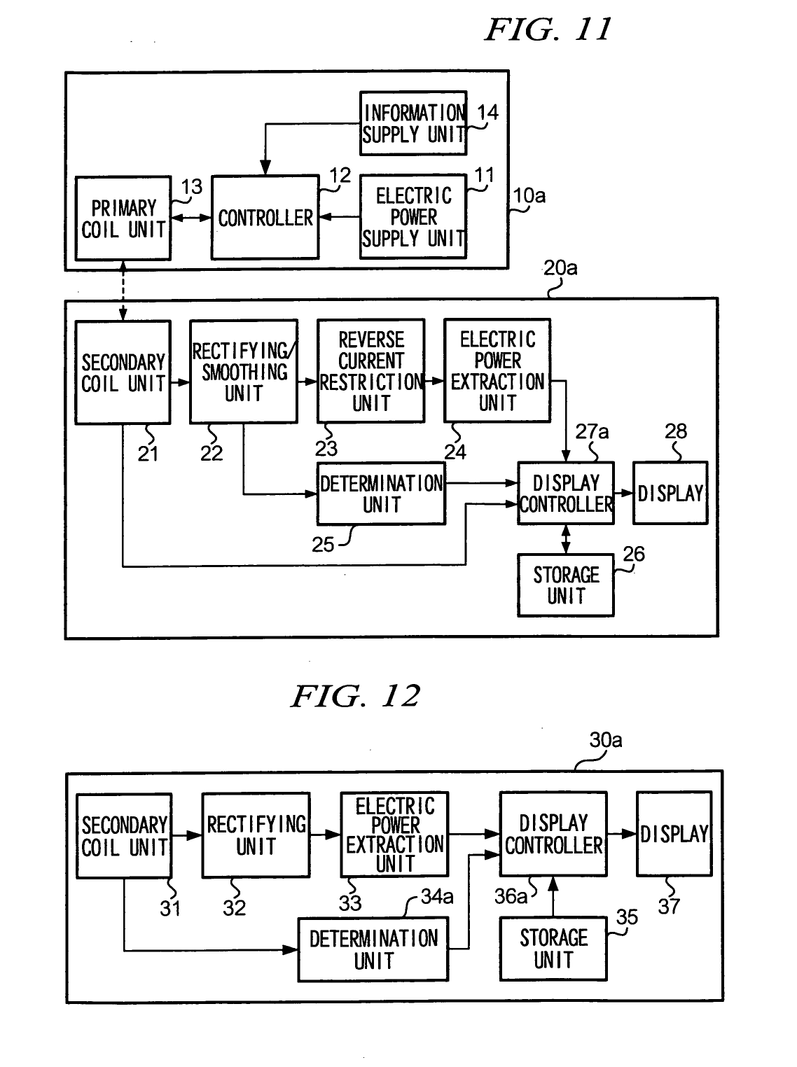

FIG. 11 shows an information display system which transmits/receives electric power and information, according to a modification to the first exemplary embodiment (shown in FIG. 2). An instruction device 10a shown in FIG. 11 differs from the instruction device 10 in that the instruction device 10a has an “information supply unit 14” and also has a “controller 12a” in place of the “controller 12”. The information supply unit 14 supplies information to be transmitted to the display device 20a. The information supply unit 14 can be of a type which reads information stored in a storage medium such as a memory card or another type which obtains and supplies information from an external device by wired or wireless communication. The controller 12a has a function to modulate information in accordance with a predetermined modulation method, in addition to the same function as that of the controller 12 described previously. Specifically, the controller 12a supplies the primary coil unit 13 with a signal which superimposes information on electric power.

A display device 20a shown in FIG. 11 differs from the display devices 20 in that the display device 20a has a “controller 27a” in place of the “display controller 27”. In addition to the same function as that of the controller 27 described previously, the controller 27a has a function to obtain an alternating current signal generated by the secondary coil unit 21 and to perform a demodulation processing to separate information and electric power from the alternating current signal. The controller 27a obtains information by the demodulation processing, and executes a processing concerning display on the display 28 in accordance with the obtained information. The obtained information which is superimposed on electric power can be display data or an instruction which orders switching of display data. The controller 27a is able to execute the processing concerning display operations by utilizing a combination of a determination signal output from the determination unit 25 and the obtained information. If the obtained information is display data, the controller 27a is able to store the obtained information into the storage unit 26.

FIG. 12 shows an example of a display device which transmits/receives electric power and information, according to another modification to the second exemplary embodiment (shown in FIG. 7). In this case, the instruction device has substantially the same structure as that shown in FIG. 11. However, the display device 30a shown in FIG. 12 differs from the display device 30 in that the display device 30a has a “determination unit 34a” in place of the “determination unit 34”, and a “controller 36a” in place of the “display controller 36”. In addition to the same function as that of the determination unit 34, the determination unit 34a has a function to specify which spiral coil has obtained information, by outputting a determination signal. In this case, determination signals are information capable of respectively identifying individuals of the spiral coils. That is, each of output determination signals is information specifying which spiral coil has output a signal to be subjected to a demodulation processing. A controller 36a has a function to control display operations of the display 28 and to execute a demodulation processing on the signal output from the spiral coil specified by the determination signal, in addition to the same functions as that of the controller 36 described previously. The controller 36a obtains information through the demodulation processing, and executes a processing concerning display operations of a display 37 in accordance with the obtained information.

The configuration for transmitting/receiving electric power and information can be different from the configurations shown in FIGS. 11 and 12.

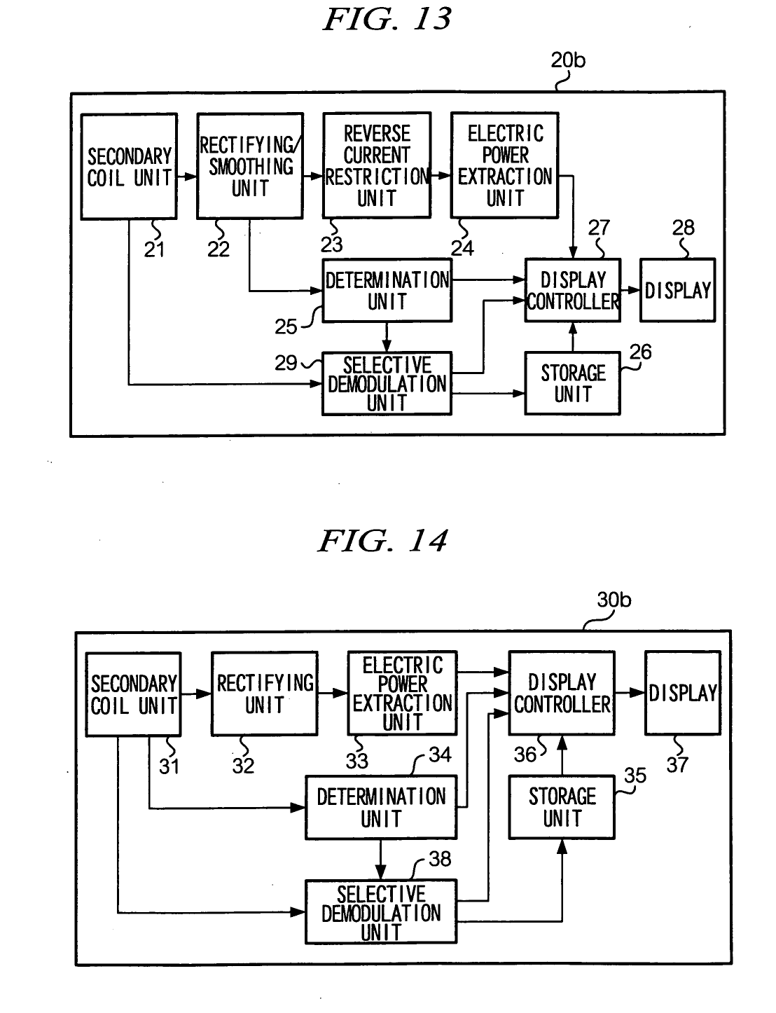

FIGS. 13 and 14 respectively show further modifications to the display devices shown in FIGS. 11 and 12, respectively. In each of the further modifications, the structure for performing the demodulation processing is separate from the controller 27a or 36a described previously. These modifications adopt the same instruction device as shown in FIG. 11.

A display device 20b shown in FIG. 13 has a selective demodulation unit 29 in addition to the structure of the display device(s) 20 shown in FIG. 2. The determination unit 25 outputs a determination signal to the selective demodulation unit 29 in addition to the display controller 27. The selective demodulation unit 29 specifies which spiral coil has output a signal to be subjected to a demodulation processing in accordance with the determination signal. The selective demodulation unit 29 further selectively executes the demodulation processing on the signal output from the specified spiral coil. If the information obtained by the demodulation processing indicates switching of display data or the like, the selective demodulation unit 29 supplies the information to the display controller 27. If the obtained information is display data, the selective demodulation unit 29 causes the storage unit 26 to store the information.

A display device 30b shown in FIG. 14 also has a selective demodulation unit 38 in addition to the structure of the display device 30 shown in FIG. 7. The selective demodulation unit 38 executes the same processing as the selective demodulation unit 29. In this case, the determination unit 34 also outputs a determination signal to the selective demodulation unit 38.

The embodiments described above each use memory liquid crystal for the display screen but any type of display medium other than memory liquid crystal can also be used. An example of another display medium having an image-retaining capability is of a micro-capsule electrophoretic type, e.g., a so-called EPD (electrophoretic display) can be used.

Further, the invention need not always be practiced as an information processing device but can be practiced as a power supply device for supplying electric power to an external device. A power supply device according to the invention has, for example, a structure equivalent to the entire of the secondary coil unit 21, the rectifying/smoothing unit 22, the reverse current reduction unit 23, the power extraction unit 24, and the determination unit 25 according to the first exemplary embodiment. In this case, the electric power extraction unit 24 is configured to supply electric power to an external device, and the determination unit 25 is configured to supply a determination signal to the external device. Another power supply device according to the invention can be configured so as to have a structure equivalent to the entire of the secondary coil unit 31, the rectifying unit 32, the electric power extraction unit 33, and the determination unit 34 according to the second exemplary embodiment. The power supply device can further be configured so as to obtain superimposed information by a demodulation processing.

What is claimed is:

1. An electric power supply device comprising:
a plurality of coils that respectively generate alternating current signals depending on a variation in magnetic flux;
a plurality of rectifying units that are respectively connected to the plurality of coils, to respectively convert the alternating current signals generated by the plurality of coils, into a plurality of direct current signals;
a restriction unit that restricts reverse flow of the plurality of direct current signals converted by the plurality of rectifying units;
an electric power supply unit that extracts and supplies electric power from the plurality of direct current signals flowing through the restriction unit; and
an output unit that specifies a direct current signal at a highest level among the plurality of direct current signals converted by the plurality of rectifying units, and outputs electronic information specifying which of the plurality of coils is connected to one of the plurality of rectifying units that has generated the direct current signal at the highest level.

2. An electric power supply device comprising:
a plurality of coils that respectively generate alternating current signals depending on a variation in magnetic flux;
a plurality of rectifying units that are respectively connected to the plurality of coils, to respectively convert the alternating current signals generated in the plurality of coils, into a plurality of direct current signals;
an electric power supply unit that extracts and supplies electric power from the plurality of direct current signals converted by the plurality of rectifying units; and
an output unit that specifies a direct current signal at the highest level among the plurality of direct current signals generated in the plurality of coils, and outputs electronic information specifying which of the plurality of coils has generated the direct current signal at the highest level.

3. The electric power supply device according to claim 1 or 2, wherein
each of the plurality of coils is sorted in any of a plurality of groups, and
the output unit is provided in a plurality so that a plurality of output units are respectively associated with the plurality of groups, and each of the plurality of output units outputs electronic information specifying any of the groups which is in association with the output unit.

4. The electric power supply device according to claim 1 or 2, wherein
each of the alternating current signals includes superimposed information modulated in accordance with a modulation method, and
the electric power supply device further comprises a demodulation unit that specifies an alternating current signal at the highest level among the plurality of alternating current signals, in accordance with the electronic information output from the output unit, and executes a demodulation processing suitable for the modulation method on the alternating current signal, thereby to obtain the superimposed information.

5. The electric power supply device according to claim 1 or 2, wherein the plurality of rectifying units respectively include smoothing units that reduce ripples in the converted plurality of direct current signals.

6. The electric power supply device according to claim 1 or 2, further comprising a plurality of capacitors that are respectively connected to the plurality of coils and resonate with an alternating current signal having a predetermined frequency.

7. An information processing device comprising:
a plurality of coils that are respectively provided at predetermined positions and also respectively generate alternating current signals depending on a variation in magnetic flux;
a plurality of rectifying units that are respectively connected to the plurality of coils, to respectively convert the alternating current signals generated in the plurality of coils, into a plurality of direct current signals;
a restriction unit that restricts reverse flow of the plurality of direct current signals converted by the plurality of rectifying units;
an electric power supply unit that extracts and supplies electric power from the plurality of direct current signals flowing through the restriction unit;
a specifying unit that specifies a direct current signal at a highest level among the plurality of direct current signals converted by the plurality of rectifying units, thereby to specify which of the plurality of coils is connected to one of the plurality of rectifying units that has generated the direct current signal at the highest level; and
a processing execution unit that executes a processing suitable for the which of the plurality of coils specified by the specifying unit, by utilizing the electric power supplied from the electric power supply unit.

8. An information processing device comprising:
a plurality of coils that are respectively provided at predetermined positions and also respectively generate alternating current signals depending on a variation in magnetic flux;
a plurality of rectifying units that are respectively connected to the plurality of coils, to respectively convert the alternating current signals generated in the plurality of coils connected, into a plurality of direct current signals;
an electric power supply unit that extracts and supplies electric power from the plurality of direct current signals converted by the plurality of rectifying units;
a specifying unit that specifies a direct current signal at a highest level among the plurality of direct current signals generated in the plurality of coils, thereby to specify which of the plurality of coils has generated the direct current signal at the highest level; and
a processing execution unit that executes a processing suitable for the which of the plurality of coils specified by the specifying unit, by utilizing the electric power supplied from the electric power supply unit.

9. A display device comprising:
a display that forms an image by using an electronic non-volatile display medium;
a plurality of coils that are respectively provided at predetermined positions and also respectively generate alternating current signals depending on a variation in magnetic flux;
a plurality of rectifying units that are respectively connected to the plurality of coils, to respectively convert the alternating current signals generated in the plurality of coils connected, into a plurality of direct current signals;
a restriction unit that restricts reverse flow of the plurality of direct current signals converted by the plurality of rectifying units;
an electric power supply unit that extracts and supplies electric power from the plurality of direct current signals flowing through the restriction unit;
a specifying unit that specifies a direct current signal at the highest level among the plurality of direct current signals converted by the plurality of rectifying units, thereby to specify which of the plurality of coils is connected to one of the plurality of rectifying units that has generated the direct current signal at the highest level; and
a processing execution unit that executes a processing suitable for the which of the plurality of coils specified by the specifying unit, by utilizing the electric power supplied from the electric power supply unit, the processing concerning the display performed by the display.

10. A display device comprising:
a display that forms an image by using an electronic non-volatile display medium;
a plurality of coils that are respectively provided at predetermined positions and also respectively generate alternating current signals depending on a variation in magnetic flux;
a plurality of rectifying units that are respectively connected to the plurality of coils, to respectively convert the alternating current signals generated in the plurality of coils connected, into a plurality of direct current signals;
an electric power supply unit that extracts and supplies electric power from the plurality of direct current signals converted by the plurality of rectifying units;
a specifying unit that specifies a direct current signal at the highest level among the plurality of direct current signals generated in the plurality of coils, thereby to specify which of the plurality of coils has generated the direct current signal at the highest level; and
a processing execution unit that executes a processing suitable for the plurality of coils specified by the specifying unit, by utilizing the electric power supplied from the electric power supply unit, the processing being display processing performed by the display.
